(19) United States
(12) Patent Application Publication
(10) Pub. No.: US 2006/0072776 A1
(43) Pub. Date: Apr. 6, 2006

(54) Amplifier and sub-woofer speaker system

(76) Inventor: Tejaswi Vishwamitra, Cincinnati, OH (US)

Correspondence Address: MICHAEL BEST & FRIEDRICH, LLP, 100 E WISCONSIN AVENUE, MILWAUKEE, WI, 53202, US

(21) Appl. No.: 10/668,677

(22) Filed: Sep. 23, 2003

Related U.S. Application Data
(63) Continuation-in-part of application No. 09/466,487, filed on Dec. 17, 1999, now Pat. No. 6,687,380.

(51) Int. Cl. H04R 1/02

(52) U.S. Cl. 381/388

(57) ABSTRACT

Some embodiments of the present invention employ a subwoofer speaker adapted to be recessed within a wall or other building structure. In another aspect of the present invention, an amplifier is adapted to be recessed within a wall or other building structure, and can be employed with the recessed subwoofer or with another component of an entertainment system. In some embodiments, the subwoofer speaker is mounted in a wall cavity and supported therein with brackets. If desired, the amplifier can be supported by a frame within a wall cavity.

This application is a continuation-in-part of U.S. patent application Ser. No. 09/466,487 filed on Dec. 17, 1999.

### BACKGROUND OF THE INVENTION

Twenty five years ago, only a small percentage of households had cable television, and VCRs were a new luxury item. Sound systems, for the most part, were limited to a small speaker built into a television, and few people had television screens larger than 27 inches. There was certainly no mistaking the typical TV room for a home theater—home theaters were expensive setups, often having actual film projectors and wide screens.

Over the years, the world of home entertainment has changed radically. Currently, many U.S. households have at least 50 television channels, a large color television, and a VCR and/or a DVD player. More and more households are adding additional advanced components to their entertainment setup to create home theater systems. Spurred by new technology triggering new product development, the world of home entertainment is changing rapidly, giving consumers a wide range of options.

Although increasingly sophisticated systems have developed for playing movies and music on conventional entertainment systems, many people continue spending money going to movie theaters and concerts. Conventional entertainment systems still often lack high quality sound typically found only in theaters, concert halls, and other venues. Also, few options are available for placement of conventional entertainment system components, resulting in undesirable system and room arrangements, disorganized and/or unsightly entertainment systems, and other shortcomings.

In many cases, it is not possible to easily place many entertainment system components in a variety of locations. For example, many sound systems have amplifiers that are intended to be stored in a cabinet or entertainment system rack, thereby limiting the locations for placement of such units. As another example, subwoofer speakers are normally relatively large devices that do not fit well into many rooms. Sub-woofers are typically used with stereo amplifiers or home entertainment systems to give an enhanced, realistic listening experience in which these lower frequencies can be heard and felt by the listener. Sub-woofer speaker systems are designed to reproduce the lowest bass frequencies in music and sound, such as frequencies in a range of 20-100 Hz (and typically below 35 Hz). However, these low frequencies cannot be reproduced by conventional smaller woofers so larger audio drivers or speakers cones having a diameter of ten (10) inches or more are typically used in sub-woofer speaker systems. Accordingly, the ability to locate such a large device in desired locations in a room is often limited.

Sub-woofers are designed to be either powered or passive. In the powered or active variety, the sub-woofer system has a built-in power amplifier to drive the sub-woofer speaker. Typically, sub-woofer systems have the power amplifier and its associated power supply mounted directly on or within the enclosure of the speaker system. Powered sub-woofers typically find use in applications where a local amplifier of a stereo or home entertainment system is limited in its output power and cannot drive the sub-woofer to its full efficiency. The powered sub-woofers therefore increase the capability of the local audio source amplifier by providing remote amplification of audio signals generated by the audio source through the use of the built-in power-supply and amplifier at the speaker.

Passive sub-woofers, on the other hand, do not have built-in power supplies or amplifiers, but rather rely on the amplifier of the audio source to drive the sub-woofer audio driver. Therefore, passive sub-woofers are generally not able to produce the same sound level as powered sub-woofers due to the limited output power of most conventional stereo amplifiers.

Typically, powered or active sub-woofers include a class-AB audio power amplifier to drive the speaker. However, class-AB audio amplifiers generally have a relatively low efficiency so a significant amount of input power to the amplifier is wasted as heat. Massive aluminum heat sinks are therefore used to keep the class-AB audio amplifier cool, which leads to increased size, weight, and cost of such amplifiers. Additionally, powered or active sub-woofer speaker systems typically use conventional E-1 laminated transformers as a power supply to drive the audio amplifier. However, E-1 laminated transformers tend to be relatively large due to their relative inefficiency and therefore preclude the use of conventionally powered sub-woofer speaker systems in closely confined spaces such as a house wall cavity.

In light of the problems and limitations of the prior art (including those described above), new entertainment system components and component mounting methods would be welcome additions to the art.

### SUMMARY OF THE INVENTION

While the present invention will be described in connection with certain embodiments, it will be understood that the invention is not limited to these embodiments. On the contrary, the invention includes all alternatives, modifications and equivalents as may be included within the spirit and scope of the present invention.

Some embodiments of the present invention provide a sub-woofer speaker system designed to be mounted in a closely confined space such as a house wall cavity, ceiling, floor or other enclosure. In some embodiments, the sub-woofer speaker system includes a power supply circuit, an audio amplifier circuit powered by the power supply circuit, and a subwoofer audio driver that is driven by the audio amplifier circuit. Low frequency audio signals are coupled from an audio source, such as a stereo amplifier or home entertainment system, to the audio amplifier circuit of the subwoofer speaker system. The audio signals are amplified by the audio amplifier and coupled to the subwoofer audio driver for reproduction of the low frequency audio information within a listening area. The subwoofer audio driver can have a diameter of about ten (10) inches to give an enhanced, realistic listening experience to the listener.

In some embodiments, the power supply circuit of the sub-woofer speaker system includes a toroidal power transformer coupled to a rectifier and filter circuit. The toroidal power transformer typically has a minimum efficiency of about 90%, and negligible leakage inductance and stray capacitance. Due to its relatively high efficiency, the toroidal power transformer is significantly smaller than conventional E-1 laminated transformers.

The audio amplifier circuit in some embodiments includes an audio preamplifier circuit having an audio input adapted to be coupled to the audio signal source and an audio output coupled to a class-D audio amplifier. The class-D audio amplifier typically has a minimum efficiency of about 90%. Due to its relatively high efficiency and minimal heat loss, the class-D power amplifier is significantly smaller and lighter than conventional class-AB audio amplifiers. Each of the audio preamplifier circuit and class-D audio amplifier circuit can be coupled to the rectifier and filter circuit for receiving DC power therefrom. In some embodiments, a sub-woofer audio driver is coupled to an audio output of the class-D amplifier and is operable to produce low frequency audio information in response to audio signals coupled to the preamplifier circuit from the audio source. The power supply circuit, the audio amplifier circuit, and the sub-woofer audio driver can have a low profile, such as a depth of less than about four (4) inches, so the sub-woofer speaker system can be readily mounted in a closely confined space such as a house wall cavity, floor, ceiling or other low profile enclosure.

It will be appreciated that a high-efficiency transformer (e.g., a minimum 90% efficiency toroidal power transformer with negligible leakage inductance and stray capacitance) can permit a smaller power transformer to be used in the sub-woofer speaker system of the present invention over the conventional E-1 laminated power transformers of the past. Moreover, it will also be appreciated that a high-efficiency amplifier (e.g., a 90% efficiency digital class-D audio amplifier with minimal heat loss) can permit a smaller and lighter audio amplifier to be used in the sub-woofer speaker system of the present invention over the conventional class-AB audio amplifiers of the past. The combination of a toroidal power transformer, class-D audio amplifier, and sub-woofer audio driver, each having a low profile of less than about four (4) inches, permits the sub-woofer speaker system of the present invention to be readily mounted in a closely confined space for reproducing low frequency audio information from an audio source.

Some embodiments of the present invention provide a subwoofer speaker adapted for recessed installation in a building structure, wherein the subwoofer speaker comprises a housing having a height, a width, and a depth dimensioned to be recessed within the building structure, a driver movable to produce waves, and an elongated internal chamber within the housing and through which waves produced by the driver propagate, the elongated chamber having a height along the height of the housing and a cross-sectional width, the height of the chamber being no less than 2.7 times the width of the chamber.

In some embodiments, an amplifier adapted for recessed installation in a building structure is provided, and comprises a housing having a height, a width, and a depth dimensioned to be recessed within the building structure, a power supply circuit located within the housing, and an audio amplifier circuit located within the housing and coupled to the power supply circuit for receiving power therefrom, the audio amplifier circuit adapted to be coupled to a source of audio signals, wherein the height of the housing is no less than 3.0 times the depth of the housing, and the width of the housing is no less than 2.0 times the depth of the housing.

In another aspect of the present invention, a subwoofer speaker adapted for recessed installation in a building structure is provided, and comprises an elongated housing having a height defined along a longitudinal axis of the elongated housing, a width, a depth dimensioned to be recessed within the building structure, an internal chamber defined by walls of the elongated housing, the internal chamber having a height extending along the longitudinal axis of the elongated housing, and a width, wherein the height of the chamber is no less than 2.7 times the width of the chamber, and a driver movable to generate waves propagating from the driver in a direction oriented at least 45 degrees with respect to the longitudinal axis of the elongated chamber.

In another aspect of the present invention, a method of producing sound with a subwoofer speaker is provided, and comprises moving a subwoofer driver to generate sound waves, propagating the sound waves within and along an elongated chamber recessed within a building structure, the elongated chamber having a longitudinal axis, a height along the building structure and the longitudinal axis, and a depth recessed within the building structure, wherein the height of the elongated chamber is no less than 5.5 times the depth of the elongated chamber, and emitting sound waves from a surface of the subwoofer driver to an area adjacent the building structure in a direction oriented at least 45 degrees with respect to the longitudinal axis of the elongated chamber.

In some embodiments, an amplifier mounting structure for mounting an amplifier in a recessed position within a building structure is provided, and comprises a frame shaped to receive the amplifier, the frame having at least one mounting location at which the frame is adapted to be mounted within a cavity in the building structure, and a fastener connecting the amplifier to and within the frame.

Also, some embodiments of the present invention provide a method of installing an amplifier in a recessed position within a building structure, wherein the method comprises mounting a frame within a cavity in the building structure, inserting a rear portion of the amplifier into the cavity and inside the frame, pushing the amplifier to a recessed position within the building structure, and supporting the amplifier within the frame.

In another aspect of the present invention, a bracket for electrically connecting an amplifier having an electrical connector and recessed within a cavity of a building structure is provided, and comprises a first portion adapted to be mounted to the building structure in a first location within the cavity, a second portion extending to a second location a distance from the first location, and an electrical connector mounted to the second portion at the second location, the electrical connector of the bracket positioned in the second location to connect with the electrical connector of the amplifier upon insertion of the amplifier into the cavity.

In yet another aspect of the present invention, a method of electrically connecting an amplifier within a building structure is provided, and comprises inserting the amplifier into a cavity of the building structure, pushing the amplifier into a recessed position within the cavity, and establishing an electrical connection to the amplifier by pushing the amplifier into the recessed position within the cavity.

More information and a better understanding of the present invention can be achieved by reference to the following drawings and detailed description.

### BRIEF DESCRIPTION OF THE DRAWINGS

The present invention is further described with reference to the accompanying drawings, which show preferred embodiments of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

FIG. 1 is a perspective view of an active subwoofer speaker system in accordance with an exemplary embodiment of the present invention, illustrating mounting of the speaker system in a wall;

FIG. 2 is a schematic of the speaker system shown in FIG. 1;

FIG. 3 is schematic of a room arranged for a home theater system;

FIG. 4 is an exploded perspective view of a subwoofer being installed in a wall cavity;

FIG. 5 is side cross-sectional view of the subwoofer illustrated in FIG. 4, taken along line 5-5 of FIG. 4;

FIG. 6A is a perspective view of an amplifier mounted according to an exemplary embodiment of the present invention;

FIG. 6B is a top view of the amplifier illustrated in FIG. 6A;

FIG. 7 is a perspective view of the frame employed to mount the amplifier as shown in FIG. 6;

FIG. 8 is a wiring schematic of the subwoofer, the amplifier, and other speakers according to an exemplary embodiment of the present invention;

FIG. 9 is a perspective view of a subwoofer mounted according to another exemplary embodiment of the present invention; and

FIG. 10 is a perspective view of a frame employed to mount the subwoofer as shown in FIG. 9.

### DETAILED DESCRIPTION

Before embodiments of the invention are explained in detail, it is to be understood that the invention is not limited in its application to the details of the examples set forth in the following description or illustrated in the drawings. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” and “coupled” are used broadly and encompass both direct and indirect mounting, connecting, and coupling. Further, “connected” and “coupled” are not restricted to physical or mechanical connections or couplings.

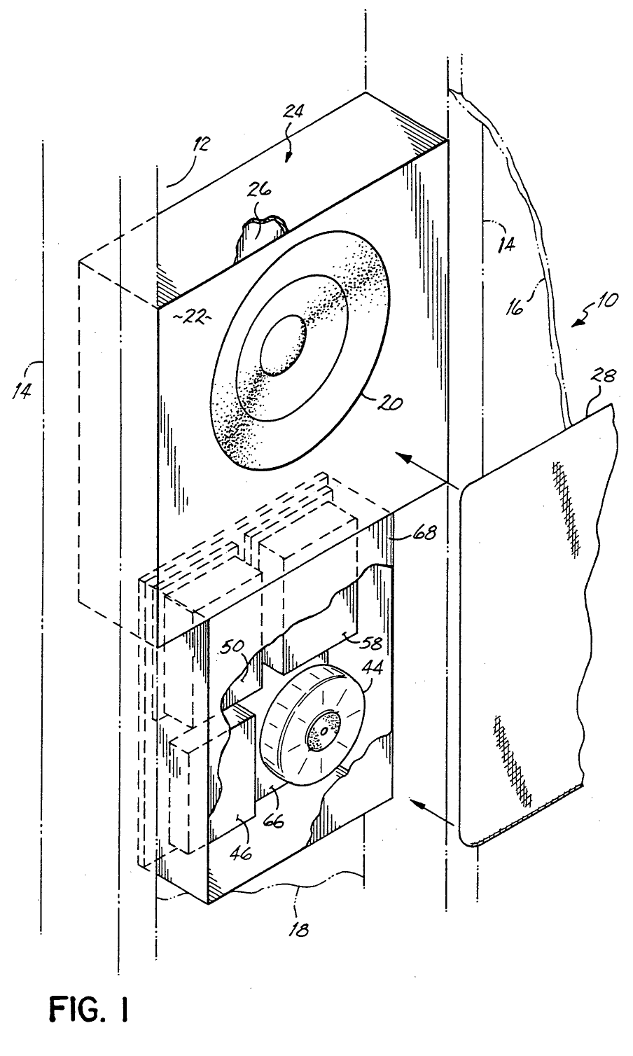

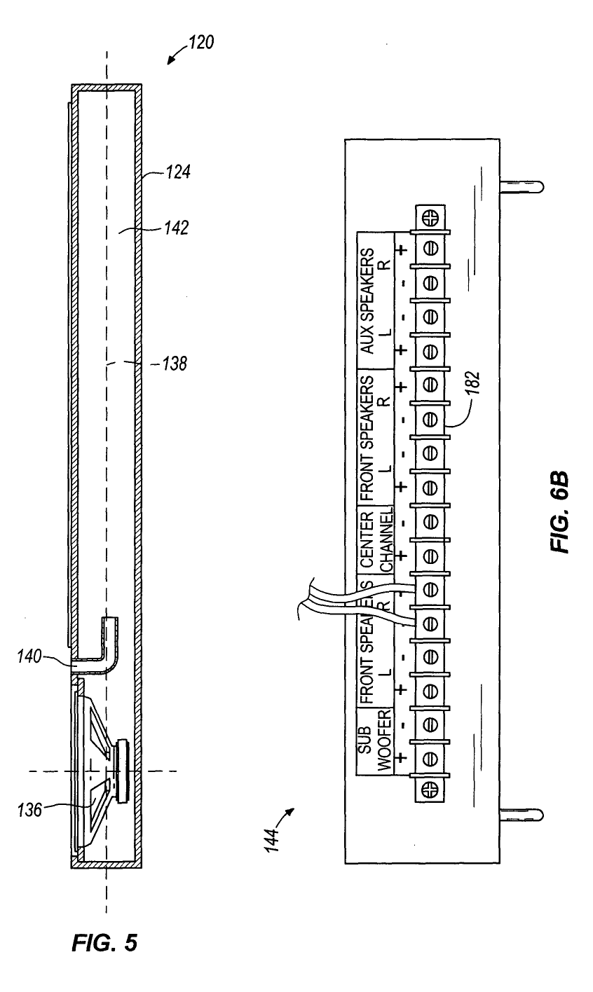

With reference to FIGS. 1 and 5, an active subwoofer speaker system 10 according to an exemplary embodiment of the present invention is shown. As will be described in more detail below, this exemplary subwoofer speaker system 10 is constructed to be installed in a closely confined space such as a house wall cavity 12 that is defined by a pair of vertical studs 14, a front partition 16 facing the listening area, and a rear partition 18 spaced from the front partition 16.

Subwoofer speaker 10 preferably includes an audio driver or speaker cone 20 having a diameter of at least ten (10) inches that is mounted to a baffle 22 through a conventional basket (not shown). An enclosure 24 is mounted on the rear side of the baffle 22 so that a forward side of the speaker cone 20 is in contact with air outside of the enclosure 24, while a specific volume of air is enclosed within a chamber 26 formed by the enclosure 24 on the rear side of the speaker cone 20. Alternatively, the enclosure 24 could be used only as a mounting frame to mount the subwoofer audio driver 20 and support its associated amplifier and power supply components. In this case, the air inside the entire wall cavity between a pair of adjacent vertical studs 14 will provide the necessary volume of air on the rear side of speaker cone 20. While not shown, it will be appreciated that suitable mounting hardware is provided to mount the baffle 22, audio driver 20 and enclosure 24 to the pair of vertical studs 14 so that the subwoofer speaker 10 is securely mounted in the wall cavity 12. A mesh grille 28 is provided to cover the subwoofer speaker 10 after it has been mounted in the wall cavity 12 to provide an aesthetic appearance or finish to the speaker.

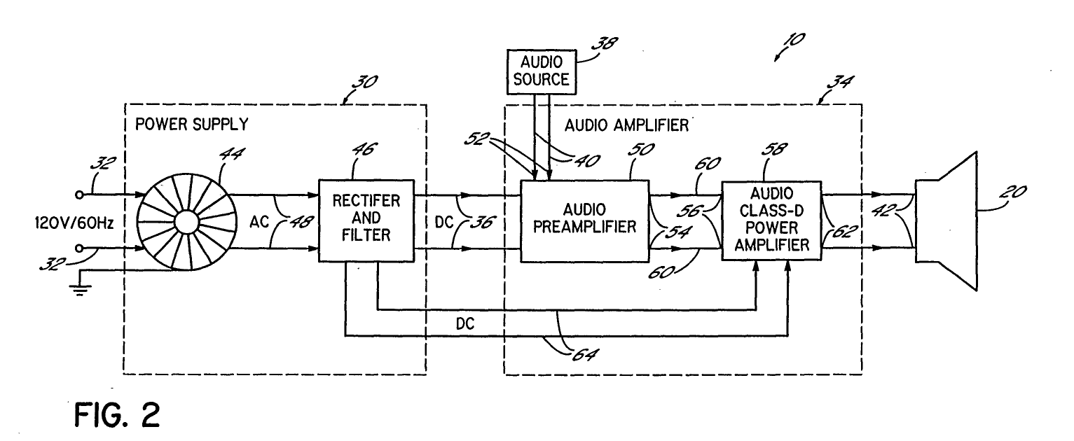

As shown in FIG. 2, subwoofer speaker system 10 includes a power supply circuit 30 that has a power input electrically coupled to 120V AC line power through AC power leads 32, and a power output electrically coupled to an audio amplifier circuit 34 through DC power leads 36. The audio amplifier circuit 34 is adapted to be electrically coupled to an audio source 38, such as a stereo amplifier or home theater system, to receive audio signals generated by the audio source 38 through leads 40. The audio amplifier circuit 34 is further electrically coupled to the sub-woofer audio driver 20 through leads 42 to reproduce the audio signals received from the audio source 38.

More particularly, power supply circuit 30 preferably includes a toroidal power transformer 44 having a toroidal magnetic core (not shown), a primary winding on the core coupled to the 120V AC line power through the AC power leads 32, and a secondary winding on the core coupled to an enclosed DC power supply or rectifier and filter circuit 46 through AC power leads 48. A suitable toroidal power transformer 44 is commercially available from Plitron Manufacturing Inc. of Toronto, Canada as Model No. 7178-B1-01. A suitable rectifier and filter circuit 46 is commercially available from NuTone Inc. of Cincinnati, Ohio, assignee of the present invention, as Model No. 26PB3.

Audio amplifier circuit 34 preferably includes an enclosed audio preamplifier circuit 50 having an audio input 52 adapted to receive audio signals from the audio source 38 through the leads 40. An audio output 54 of the audio amplifier circuit 50 is electrically coupled to an audio input 56 of an enclosed digital class-D audio amplifier 58 through leads 60. A suitable audio preamplifier circuit 50 is commercially available from NuTone Inc. as Model No. 26PB4. A suitable digital class-D audio amplifier 58 is commercially available from NuTone Inc. as Model No. 26PB13. The class-D audio amplifier 58 has an audio output 62 that is coupled to the subwoofer audio driver 20 through the leads 42. The rectifier and filter circuit 46 is operable to electrically couple DC power to the audio preamplifier circuit 50 through the DC power leads 36. The rectifier and filter circuit 46 also is operable to electrically couple DC power to the digital class-D audio amplifier 58 through DC power leads 64.

As shown in FIG. 1, each of the toroidal power transformer 44, rectifier and filter 46, audio preamplifier circuit 50 and digital class-D audio amplifier 58 are mounted on a generally planar support member 66. An inner enclosure (not shown) and an outer enclosure 68 are supported in the wall cavity 12 to enclose the assembly of components 44, 46, 50 and 58. While not shown in FIG. 1, it will be appreciated that suitable mounting hardware is provided to support the assembly of components 44, 46, 50 and 58 within the wall cavity 12.

In use, the exemplary subwoofer speaker system 10 illustrated in FIG. 1 can be mounted within a confined space such as the wall cavity 12 though the mounting hardware (not shown in FIG. 1). The toroidal power transformer 44 in this exemplary embodiment is electrically coupled to 120V AC line power through the AC power lines 32, and the audio source 38 is electrically coupled to the audio preamplifier circuit 50 through leads 40. Audio signals coupled to the audio preamplifier circuit 50 are coupled to the audio input 56 of the digital class-D audio amplifier 58 through leads 60. The class-D audio amplifier 58 applies amplified audio signals at its audio output 62 to the subwoofer audio driver 20 through leads 42. In this way, low frequency audio information is reproduced by the subwoofer audio driver 20 from the audio signals received from the audio source 38 on leads 40.

It will be appreciated that while the subwoofer speaker system 10 is shown mounted in wall cavity 12, in other embodiments of the present invention, the subwoofer speaker system 10 can be mounted in a speaker enclosure (not shown), a ceiling (not shown) or a floor (not shown) as will be appreciated by those skilled in the art. As shown in FIG. 1, each of the toroidal power transformer 44, rectifier and filter 46, audio preamplifier circuit 50 and digital class-D audio amplifier 58 preferably have a shallow depth preferably less than four (4) inches, and more preferably less than three and one-half (3.50) inches. Additionally, the subwoofer audio driver 20 preferably has a shallow depth preferably less than four (4) inches, and more preferably less than three and one-half (3.50) inches. In this way, the active subwoofer system 10 can be easily mounted in confined spaces such as the house wall cavity 12 to free up floor space within the listening area.

It will be appreciated that the minimum 90% efficiency of many toroidal power transformers (with negligible leakage inductance and stray capacitance) such as the transformer 44 in FIGS. 1 and 2 permits a smaller power transformer to be used in subwoofer speaker systems according to the present invention. Moreover, it will also be appreciated that the minimum 90% efficiency of many digital class-D audio amplifiers (with its minimal heat loss) such as the amplifier 58 in FIGS. 1 and 2 permits a smaller and lighter audio amplifier to be used. The combination of a toroidal power transformer 44, a class-D audio amplifier 58 and a subwoofer audio driver 20, each having a low profile of less than about four (4) inches, permits the subwoofer speaker system 10 according to some embodiments of the present invention to be readily mounted in a closely confined space for reproducing low frequency audio information from audio source 38.

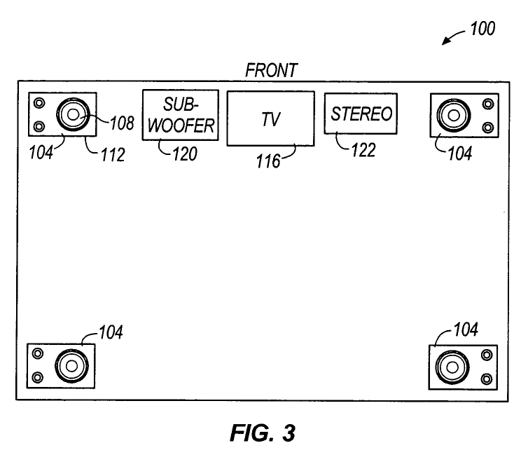

In some embodiments of the present invention (see, for example, the exemplary system illustrated in FIGS. 3-8), a home theater system is provided using audio components such as speakers, amplifiers, and the like. Generally speaking, a home theater system is a combination of electronic components designed to enhance the experience of listening to music or other sound, to recreate the experience of watching a movie in a theater, and the like. For example, when a movie is viewed on a home theater system, the viewer is more immersed in the experience than when viewed on an ordinary television.

Generally, a sound system (used with or without a television) includes two or more speakers positioned throughout a room. In some cases, sound can be controlled such that different sound is produced by different speakers in the system. For example, the audio signal to two or more speakers can be different to provide a stereo effect as is well known in the art. As another example, a surround sound effect can be generated in a similar manner, often by employing multiple speakers positioned around a listener (e.g., two to three speakers in front of a room and two to three speakers in the back and sides of the room). The sounds generated by each speaker can come from the same audio signal split into multiple channels. For example, with regard to the audio of a movie, when a sound is produced on the left side of the screen, a corresponding sound can be generated by a speaker to the left of the television (and the viewer). When a sound is produced on the right side of the screen, a corresponding sound can be generated by a speaker to the right of the television (and the viewer).

In some systems, a third speaker (the center speaker), is positioned between front speakers of a sound system. For example, a center speaker can be employed to produce dialogue at or near the center of a television system. The center speaker directs the dialogue and front sound effects so that they seem to be coming from the area of the television.

When employed, speakers positioned in the back of the room can be used to produce any desired sounds (e.g., instruments, background sound in a movie, and the like). The rear speakers can also work with front speakers to give the sensation of movement, such as to simulate the movement of a sound-producing object or person.

In some systems, another speaker, the subwoofer, can be positioned in the room to provide low frequency or deep bass sounds. The subwoofer is capable of producing frequencies at or below 100 Hz. By virtue of their relatively low frequency, subwoofers can be positioned in more locations without detrimental impact to overall sound performance of a system.

Referring to FIG. 3, a room 100 having a sound system is illustrated. The room 100 includes a plurality of speakers 104. The speakers 104 in the illustrated exemplary arrangement include left and right front speakers 104 and left and right rear speakers 104. The arrangement of the speakers 104 can be modified from the arrangement shown, and can include more or fewer speakers as desired. In some cases, the number and location of speakers 104 is at least partially dependent upon room size, room acoustics, a desired sound output, and other factors. The speakers 104 can be mounted in walls or the ceiling of the room 100, can be suspended in any manner (e.g., one or more brackets, frames, and the like mounted to walls or the ceiling), can be free-standing on a floor of the room 100, and/or can be located in any other manner in the room 100.

Each speaker 104 generally includes a driver 108. The driver 108 can include a cone or diaphragm comprised or any suitable material (e.g., paper, plastic or metal), can include an electrically charged mesh, or can take any other form capable of producing sound waves. Some embodiments of the speaker 104 also include a surround, which is a rim of flexible material attached to the driver's frame or basket that allows the cone, diaphragm, or other sound-generating component to move. In the case of cone-type drivers, the speakers 104 can each also include a voice coil connected to a rear end of the cone and that moves in and out with the cone. In some embodiments, the voice coil is suspended within the magnetic field of a permanent magnet such that it moves back and forth with the applied frequency signal in a manner known to those skilled in the art.

The speakers 104 according to some embodiments include a housing or cabinet 112 that can include a woofer, a tweeter, and/or a midrange driver. Any one or combination of these sound-producing components can be employed as desired in each speaker 104. Each of the woofer, the tweeter, and the midrange driver reproduce different frequencies that, when combined in a home theater system setting, provide enhanced audio performance. The woofer can include the largest driver and is designed to reproduce low frequency sounds. The tweeter can include the smallest driver and is designed to reproduce the highest frequency sounds. The midrange driver can include a medium-sized driver and is designed to reproduce a range of frequencies in the middle of the sound spectrum.

The entertainment system in the exemplary room 100 illustrated in FIG. 3 includes a television or screen 116. The screen 116 can be positioned at a middle location between opposing walls of the room 100 as shown in FIG. 3, but could instead be positioned anywhere else in the room 100 depending at least in part upon the size of the room 100, the desired viewing angle, and the positions of the speakers 104. As mentioned earlier, the entertainment system illustrated in FIG. 3, can also include a subwoofer 120. The subwoofer 120 can be positioned anywhere in the room 100, and can be active or passive. An active subwoofer includes a power amplifier to drive the subwoofer speaker. A passive subwoofer is powered by an external amplifier (e.g., an amplifier in the audio source or stereo receiver), rather than by a dedicated power amplifier of the subwoofer.

In some embodiments, the entertainment system also includes an audio source or stereo system 122 as shown in the exemplary room of FIG. 3. The stereo system 122 includes an amplifier that produces audio signals. The audio signals are transmitted to the speakers 104 and the subwoofer 120 (if employed). The stereo system 122 can also include a receiver, a cassette player, a compact disc player, an additional amplifier, an equalizer, and/or other components. As is well known in the art, the stereo system 122 can be configured in a variety of ways to enable audio play of signals from the television or screen 116, a VCR player or DVD player, or any other component.

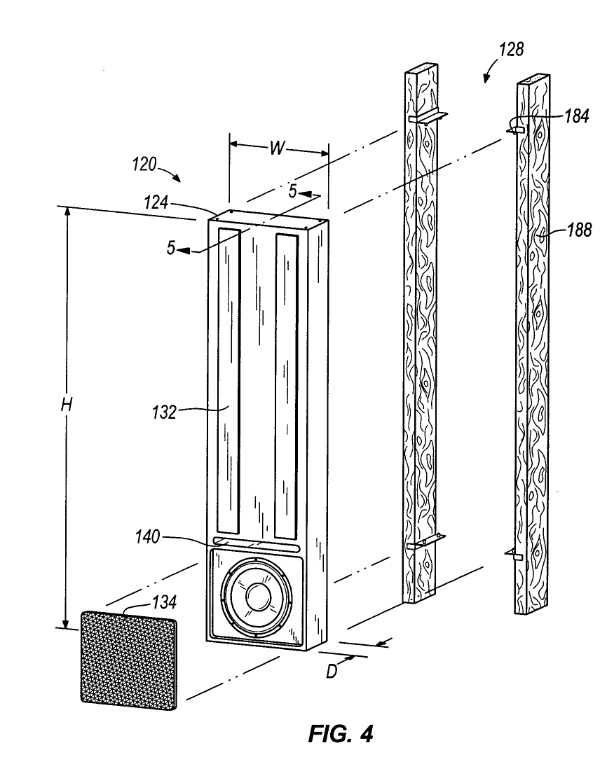

FIG. 4 illustrates an exemplary subwoofer 120 according to an embodiment of the present invention. The subwoofer 120 is adapted for installation within a building structure, such as within a wall, a floor, a ceiling, and the like. The vast majority of building structures (in homes, offices, and other buildings) employ walls, floors, and ceilings having certain dimensional constraints. For example, many walls have interior spaces that are approximately 3 ½″ in depth (in those cases in which standard 2×4 or 4×4 studs are employed as internal structure of the wall) or under 6″ in depth (in those cases in which 2×6 studs are employed). As another example, many floors and ceilings have interior spaces with similar depths. Also, the interior spaces of many walls, ceilings, and floors have a width of just under 10″, 14″, 16″, or 18″ defined between parallel studs or beams running within the floor or ceiling. More specifically, such spaces are often defined by studs or beams located 10″, 14″, 16″, or 18″ apart measured from a center of each stud or beam, thereby leaving a width between studs or beams of between 2 and 6 inches less than these dimensions (e.g., 8.5″, 12.5″, 14.5″, and 16.5″). These and other standard spacings between wall, floor, and ceiling elements represent possible constraints upon the size and shape of entertainment system components that can be recessed within the building structure according to the present invention.

In some embodiments, the subwoofer 120 has a shape suitable to be recessed in a building structure. For example, the subwoofer 120 illustrated in FIG. 4 has an elongated shape that is relatively narrow and shallow (described in greater detail below) as shown in the illustrated embodiment in FIG. 4. This shape permits the subwoofer 120 to be recessed within many conventional building structures (such as a wall, floor, or ceiling described above) while still having the necessary internal dimensions for proper subwoofer operation.

In some embodiments, the depth of the subwoofer 120 is selected depending at least partially upon the building structure cavity in which the subwoofer 120 is to be recessed. For example, in a case where the cavity is in a wall of a building structure separating two rooms, the depth of the subwoofer 120 can be limited to the depth of the cavity or to a smaller depth. In other cases, the depth of the subwoofer 120 is not limited to the depth of the cavity, in which cases the subwoofer 120 can extend further in a rearward and/or forward direction if needed or desired to be partially recessed within the building structure. For example, in some embodiments the subwoofer 120 can extend out of an open back of a wall.

With reference again to FIG. 4, the exemplary illustrated subwoofer 120 includes a housing 124 having a height H, a width W, and a depth D. The housing 124 can vary in size, but in some embodiments is no larger than the size of a cavity within a building structure (for example, a wall cavity 128 illustrated in FIG. 4). In the embodiment illustrated in FIG. 4, the wall cavity 128 is the space between two adjacent wall studs extending from floor to ceiling. It should be noted that the size of the cavity and shape of the space in which the subwoofer 120 can be installed and recessed can vary and can depending upon the particular location (e.g., wall, ceiling, floor or any other building structure).

In the illustrated exemplary embodiment of FIGS. 4 and 5, the building structure (in which the subwoofer 120 is adapted to be installed) is a wall. However, it should be noted that this building structure and installation is presented by way of example only. The principles of the present invention as described in connection with the subwoofer 120 of FIGS. 4 and 5 are equally applicable to subwoofer installation in a ceiling, floor, or any other building structure. With reference again to FIGS. 4 and 5, the housing 124 can be recessed in a cavity 128 in the wall. In some embodiments, a housing height H that is at least 1.35 times the housing width W is employed to provide sufficient interior space in the housing 124 for proper subwoofer operation. In other embodiments, a housing height H that is at least 2.7 times the housing width W provides good performance results. In still other embodiments, a housing height H that is at least 5.0 times the housing width W provides good performance results. In some embodiments of the present invention, the internal chamber 142 of the housing 124 has the same ratios of height H to width W as just described.

Another parameter that is relevant to the performance of some subwoofers according to the present invention is the ratio of the housing depth D to the housing height H. Like the ratio of the housing width W to the housing height H, the depth to height ratio can impact the performance of the subwoofer 120, and the capability to install the subwoofer 120 in standard building structure cavities. In some embodiments, a housing height H that is at least 5.5 times the housing depth D is employed to provide sufficient interior space in the housing 124 for proper subwoofer operation. In other embodiments, a housing height H that is at least 11.5 times the housing depth D provides good performance results. In still other embodiments, a housing height H that is at least 23.0 times the housing depth D provides good performance results. In some embodiments of the present invention, the internal chamber 142 of the housing 124 has the same ratios of height H to depth D as just described.

In some embodiments, the housing 124 has a width W of no greater than 12 inches. In other embodiments, the housing 124 has a width W of no greater than 16 inches. Also, in some embodiments, the housing 124 has a depth no greater than 4 inches. In other embodiments, the housing 124 has a depth no greater than 3.25 inches. As discussed above, if the back wall of the wall cavity 128 is open-ended or at least partially open, the depth D of the housing 124 can be larger than 4 inches in some embodiments. These dimensions of the width W and depth D can be employed in the housing 124 having any of the ratios of height H to width W and depth D to height H described above. It should be noted that the terms height H, width W, and depth D are employed herein and in the appended claims with reference to various features and elements of the subwoofer 120 for ease of description only, and do not alone indicate or imply that the housing 124 or any feature or element thereof must be oriented in any particular manner (e.g. vertically). The housing 124 and the subwoofer 120 can be oriented in any manner necessary or desired for installation in any building structure. In this regard, the cavity 128 can be located in a wall, floor, ceiling or any other part of a building structure. The cavity 128 is at least partially defined, for example, by the space between two adjacent ceiling studs, floor studs, or wall studs 188.

The housing 124 can include a material 132 designed to absorb vibration and/or heat. The material 132 can be located on any surface of the housing 124, and in the illustrated embodiment in FIG. 4 is applied in strips on a front surface of the housing 124 by way of example only. The material can be comprised of polystyrene, polyurethane, rubber, and any other heat and/or vibration-absorbing material or combinations thereof.

In some embodiments, the subwoofer 120 can also include one or more panels 134 to cover the components of the subwoofer 120 (such as subwoofer components discussed above with respect to FIGS. 1 and 2). The panel(s) 134 can also serve to increase the aesthetic appeal of the subwoofer 120 and/or to hide the subwoofer 120 when installed. Each panel 134 can be a grille, a decorative plate, a fabric or mesh cover, or any other suitable cover that allows sound waves to travel through the panel 134 and to enter the room 100.

Referring to FIG. 5, some embodiments of the present invention provide a subwoofer 120 having an elongated shape and a driver 136 oriented at an angle greater than zero degrees with respect to a longitudinal axis 138 of the subwoofer 120 (or subwoofer housing 124). In this regard, the longitudinal axis 138 of the subwoofer 120 or subwoofer housing 124 is that axis running through the longest dimension of the subwoofer 120. In such embodiments, the subwoofer 120 has an elongated length that is at least 1.1 times the sum of the width W and depth D of the subwoofer 120. However, the subwoofer 120 in such embodiments can instead have an elongated length that is at least 2.2 times the sum of the width W and depth D of the subwoofer 120. Alternatively, the subwoofer 120 in such embodiments having an elongated length at least 4.4 times the sum of the width W and depth D of the subwoofer also provides good performance results. In some embodiments of the present invention, the internal chamber 142 of the housing 124 has the same lengths as just described with reference to the subwoofer 120.

Conventional subwoofers employ a driver oriented to emit sound waves in a direction parallel to the longitudinal axis of the subwoofer (e.g., capping the end of a tube or elongated cabinet). However, in the elongated subwoofer embodiments just described, the driver 136 can be oriented at any angle greater than zero degrees with respect to the longitudinal axis 138 of the subwoofer 120. In some embodiments, the driver 136 is oriented at an angle no less than 45 degrees with respect to the longitudinal axis 138 of the subwoofer 120. In still other embodiments, the driver 136 is oriented at an angle no less than 80 degrees with respect to the longitudinal axis 138 of the subwoofer 120. In the illustrated exemplary embodiment, the driver 136 is oriented at approximately 90 degrees with respect to the longitudinal axis 138 of the subwoofer 120.

Some embodiments of the subwoofer 120 according to the present invention include an air port 140 establishing fluid communication between an internal chamber 142 of the housing 124 and the outside of the housing 124, thereby defining a bass reflex housing 124. A bass reflex housing 124 redirects inward pressure of the subwoofer 120 outward, wherein movement of the driver pushes sound waves out of the air port 140.

In some embodiments, the air port 140 has an elongated shape. In the illustrated embodiment in FIG. 5 for example, the air port 140 has a width W and a height H that is a fraction of the width W. The air port 140 can have a width W that is at least 2.0 times the height H of the air port 140. In other embodiments, an air port 140 having a width W at least 4.0 times the height H of the air port 140 provides good performance results. In still other embodiments, an air port 140 having a width W at least 8.0 times the height H of the air port 140 provides good performance results. Although the air port 140 can have any shape desired, some embodiments of the present invention employ an air port 140 having substantially parallel elongated sides (e.g., see FIG. 4).

In some embodiments of the present invention, the subwoofer 120 is installed within a wall cavity 128 using one or more brackets 184. By way of example only, the subwoofer 120 illustrated in FIG. 4 is secured within the wall cavity 128 by four brackets 184 (two upper and two lower brackets 184), although more or fewer brackets 184 could be used to support the subwoofer 120. The brackets 184 can be comprised of metal, wood, plastic, composite, or any other suitable material. The brackets 184 can be connected to or releasably or permanently engage the subwoofer housing 124 via pins, screws, bolts, nails, rivets, or other conventional fasteners, a tongue and groove connection with the housing 124, snap-fit or inter-engaging elements on the brackets 184 and housing 124, and the like. The shape of the brackets 184 is not limited to that shown in FIG. 4. Any bracket capable of supporting the subwoofer 120 with respect to the wall studs 188 or other adjacent structure can be used in the wall cavity 128.

The brackets 184 can be pre-installed on the subwoofer 120 or can be provided separately for installation on wall studs 188 or other adjacent structure within which the subwoofer 120 is to be mounted and supported. In either case, the brackets 184 can be secured to the wall studs 188 or other adjacent structure by screws, nails, adhesive or cohesive bonding material, clamps, pins, or other fastening elements or devices (not shown). The brackets 184 can thereby be mounted to the wall studs 188 or other adjacent structure to support the subwoofer 120. In those embodiments in which the brackets 184 are separate from the subwoofer 120 and are first attached to the wall studs 188 or other adjacent structure, the subwoofer 120 can be positioned on the brackets 184 and slid into place until the housing 124 is recessed within the wall.

In some embodiments, one end of the subwoofer 120 is first received within the wall and rests upon or is otherwise supported by at least one bracket 184, after which time the subwoofer 120 is pivoted into a recessed position in the wall. In such cases, one or more additional brackets 184 (e.g., located at an opposite end of the subwoofer 120) can be positioned to engage or otherwise help retain the subwoofer 120 in place within the wall once pivoted into position. In other embodiments, the subwoofer 120 is slid into recessed position within the wall in which one or more brackets 184 support the subwoofer 120 (and in some cases in which the brackets 184 also connect the subwoofer 120 to the wall studs 188 or other adjacent structure). Still other manners of moving the subwoofer 120 into a recessed position in the wall and in which one or more brackets 184 support the subwoofer 120 therein are possible, and fall within the spirit and scope of the present invention

The subwoofer 120 can be fully recessed within the wall, whereby the front surface of the subwoofer 120 is flush with the wall or is recessed with respect to the front surface of the wall. In other embodiments, the front surface of the subwoofer 120 can extend outward from the wall to any extent desired.

Once installed within the wall, a piece of drywall, plaster, paneling, or other suitable material can be placed over the subwoofer 120, if desired, to cover the subwoofer while leaving the driver 136 exposed. Accordingly, in such embodiments, the majority of the subwoofer 120 is hidden from view once fully installed. If employed, the panel 134 can be connected to the subwoofer 120 to cover the driver 136. The panel 134 can be flush with the wall, extend outwardly from the wall, or recessed within the wall.

In another aspect of the present invention, an amplifier 144 is provided that is adapted to be recessed into a wall, ceiling, floor, or other building structure, and can be employed to power a subwoofer 120, such as those described above and illustrated in the figures or any other entertainment system component. In some embodiments, the amplifier 144 is a digital class-D amplifier generating sufficiently low heat to permit the amplifier 144 to be recessed as described herein.

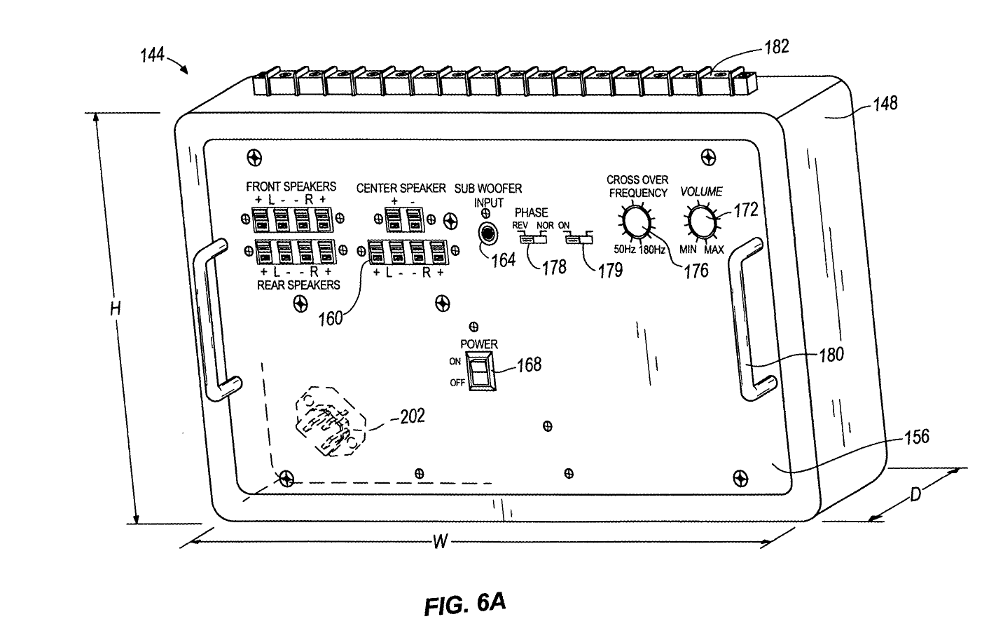

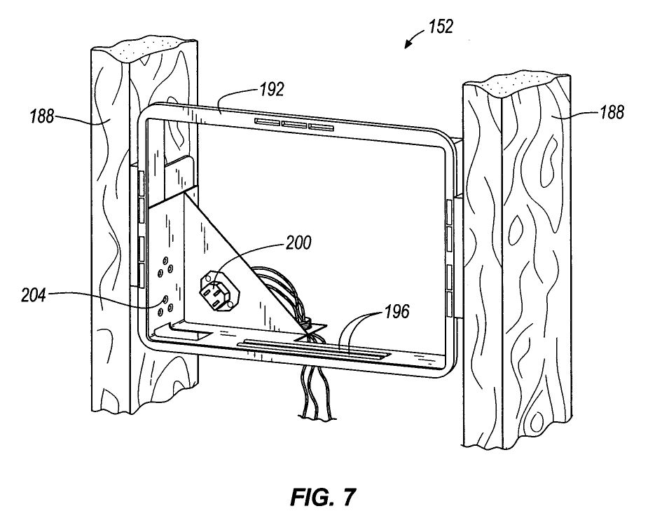

With reference again to FIGS. 6 and 6A, the exemplary illustrated amplifier 144 includes a housing 148 having a height H, a width W, and a depth D. The housing 148 can vary in size, but in some embodiments is no larger than the size of a cavity within a building structure (for example, a wall cavity defined between adjacent wall studs 188 in FIG. 7). It should be noted that the size of the cavity and shape of the space in which the amplifier 144 can be installed and recessed can vary and can depending upon the particular location (e.g., wall, ceiling, floor or any other building structure).

In the illustrated exemplary embodiment of FIGS. 6A, 6B, and 7, the building structure (in which the amplifier 144 is adapted to be installed) is a wall. However, it should be noted that this building structure and installation is presented by way of example only. The principles of the present invention as described in connection with the amplifier 144 and wall cavity of FIGS. 6A, 6B, and 7 are equally applicable to amplifier installation in a ceiling, floor, or any other building structure. With reference again to FIGS. 6A, 6B, and 7, the housing 148 can be recessed in a cavity in the wall. In some embodiments, a housing height H that is at least 3.0 times the housing depth D is employed to provide sufficient interior space in the housing 148 while still housing the necessary components of the amplifier 144. In other embodiments, a housing height H that is at least 4.0 times the housing depth D is employed. In still other embodiments, a housing height H that is at least 5.0 times the housing depth D is employed.

Another parameter that is relevant to the installation of some amplifiers 144 according to the present invention is the ratio of the housing width W to the housing depth D. Like the ratio of the housing height H to the housing depth D, the width to depth ratio can impact the ability to recess the amplifier 144 as described herein, and in some cases to substantially fully recess the amplifier 144 within standard building structure cavities. In some embodiments, a housing width W that is at least 2.0 times the housing depth D is employed to provide sufficient interior space in the housing 148 while still enabling recessed installation in a cavity of a building structure. In other embodiments, a housing width W that is at least 3.0 times the housing depth D is employed. In still other embodiments, a housing width W that is at least 4.0 times the housing depth D is employed.

In some embodiments, the housing 148 has a width W of no greater than 12 inches. In other embodiments, the housing 148 has a width W of no greater than 16 inches. Also, in some embodiments, the housing 148 has a depth no greater than 4 inches. In other embodiments, the housing 148 has a depth no greater than 3.5 inches. In those applications in which the back wall of the wall cavity is open-ended or at least partially open, the depth D of the housing 148 can be larger than 4 inches in some embodiments. These dimensions of the width W and depth D can be employed in the housing 148 having any of the ratios of height H to depth D and width W to depth D described above. It should be noted that the terms height H, width W, and depth D are employed herein for ease of description only, and do not indicate or imply that the housing 148 must be oriented in any particular manner. The housing 148 can be oriented in any manner necessary or desired for installation in any building structure. In this regard, the cavity (in which the amplifier 144 is installed) can be located in a wall, floor, ceiling or any other part of a building structure, and can be at least partially defined, for example, by the space between two adjacent ceiling studs, floor studs, or wall studs 188.

When employed to power a subwoofer 120 such as any of those described above, the amplifier 144 can be installed in a recessed fashion in a wall cavity 152 adjacent the wall cavity 128 for the subwoofer 120. Alternatively, the amplifier 144 can be installed in any location in the room 100. In some embodiments, the wall cavity 152 for the amplifier 144 is positioned as close as possible to the wall cavity 128 of the subwoofer 120, and no greater than six feet away from the wall cavity 128 of the subwoofer 120.

Some embodiments of the amplifier 144 according to the present invention include a control panel 156. The control panel 156 can have a plurality of terminals 160 adapted to receive and connect cables or wires (hereinafter “wires”) from an audio source (e.g., any entertainment center component). By way of example only, illustrated exemplary control panel 156 includes terminals 160 for connecting wires for left front and rear speakers 104, right front and rear speakers 104, left and right auxiliary speakers 104, and a center speaker 104. In other embodiments, the panel 156 can include fewer or more terminals 160 as desired. The connectors 160 can be positioned anywhere on the housing 148, and in the illustrated exemplary embodiment are located on a front surface of the housing 148 (facing away from the wall or other structure in which the amplifier 144 is recessed).

The control panel 156 can also include one or more connectors 164 adapted to receive one or more wires from an audio source (e.g., the subwoofer output of a stereo system 122) to be transmitted to a subwoofer 120. In some embodiments, the control panel 156 can also include an alternating current (“AC”) power switch 168 to indicate whether power is supplied to the amplifier 144, a volume control 172 to control the audio level of connected speakers, a cross over frequency control 176 to control upper frequency levels of connected speakers, a phase reverse switch 178 that controls the output phase of the speakers 104, and/or an on/auto switch 179 that supplies power to the subwoofer 120 in one state and automatically turns the subwoofer 120 on in another state when an audio signal is detected. In some embodiments, the amplifier 144 is also provided with one or more handles 180 to assist the user during installation of the amplifier 144.

The amplifier 144 can also include one or more additional terminals 182 positioned anywhere on the amplifier 144 for connection to one or more speakers 104. In some embodiments, additional terminals 182 are located on a top surface of the housing 148 or otherwise on any other portion of the housing 148 recessed within the wall or other structure in which the amplifier 144 is installed. This location for the terminals 182 enables speaker wires to be connected to the amplifier 144 while also being recessed within the wall or other structure in which the amplifier 144 is installed. Accordingly, such wires can be partially or entirely hidden from view (such as behind drywall, a panel, or molding covering a portion of the amplifier 144.

The cavity 152 in which the amplifier 144 is to be installed can be prepared for receiving the amplifier 144 by installing a frame 192 in the wall cavity 152 as illustrated in FIG. 7. The frame 192 can be secured to one or more studs 188 within a wall, ceiling, floor, or other building structure. By way of example only, the frame 192 in the embodiment of FIGS. 6A, 6B, and 7 is dimensioned to extend between and be mounted to two adjacent wall studs 188.

In some embodiments, the frame 192 surrounds and/or supports any portion of the amplifier 144. By way of example only, the frame 192 in the embodiment of FIG. 7 surrounds the sides, top, and bottom of the amplifier 144. As another example, the frame 192 can be adapted to surround the sides, top, bottom, and back of the amplifier 144. In both examples, the frame 192 can be shaped to receive and surround any portion of the amplifier 144 desired.

In some embodiments, the frame 192 includes one or more elements employed for securing the amplifier 144 within the frame 192. These element(s) can include screws, bolts, nails, clips, pins, snap-fit or inter-engaging elements, or any other fastening elements or mechanisms. These element(s) can be integral with the frame 192 or separate from the frame 192. For example, the frame 192 in the illustrated embodiment has ribs 196 that engage with ribs and/or recesses in the housing 148 of the amplifier 144. Alternatively, amplifier housing 148 can have one or more ribs 196 that engage with one or more recesses in the frame 192. Other examples of such inter-engaging elements that can be employed to secure the amplifier 144 in the frame include, without limitation, cooperating notches, indentations, grooves, dimples, bumps, and the like on the frame 192 and housing 148.

One or more electrical connections to the amplifier 144 in the illustrated embodiment of FIGS. 6A, 6B, and 7 can be established by insertion of the amplifier 144 in the frame 192. For example, some embodiments of the frame 192 according to the present invention include an outlet plug 200 integral with or mounted to the frame 192. The outlet plug 200 can be a male or female plug for connection to a female or male electrical connector on the amplifier 144 The outlet plug 200 on the frame 192 can be any type of electrical connector for electrical connection with any type of electrical connector 202 on the amplifier 144. In some embodiments, the frame 192 can have more than one electrical connector to support multiple electrical connections to the amplifier 144. For example, the frame 192 can include multiple electrical connectors (i.e., power and/or speaker wire connectors of any type) adapted to receive or otherwise engage with corresponding electrical connectors on the amplifier 144 such that insertion of the amplifier 144 into the frame 192 establishes some or all of the electrical connections needed to operate the amplifier 144. The electrical connector(s) 200 can be located in any position on the frame 192 for alignment with and connection to electrical connector(s) on the amplifier 144 received within the frame 192, such as in one or more corners of the frame 192, on one or more sides of the frame 192, and/or in an interior location of the frame 192.

As described above, the electrical connector(s) 200 on the frame 192 can be located anywhere on the frame 192 for connection to one or more electrical connectors on the amplifier 144. In the illustrated exemplary embodiment, the electrical connector 200 is located on a wall of the frame 192 that is substantially perpendicular to the direction of insertion of the amplifier 144. The wall in which the electrical connector 200 is installed can serve another valuable function—to at least partially enclose or separate a portion of the frame 192 in which wiring and wiring connection are located from other portions of the frame 192. In particular, it can be desirable to at least partially enclose power supply wiring (from the household or building power supply) and their connections to the amplifier 144 from other locations behind and around the amplifier 144. In some cases, such a separation or enclosure can be required by local building codes. Accordingly, the wall in which the connector 200 illustrated in FIG. 7 is mounted separates the connector 200 (and adjacent portion of the amplifier 144) from power supply wiring and wiring connections made to the household or building power supply. Although only a single triangular wall of the frame 192 is illustrated by way of example in FIG. 7 for this purpose, it will be appreciated that any number of walls having any shape can be employed to define a partial or full enclosure (e.g., a junction box or enclosure) for such wiring and wiring connections. One or more grounding pins or screws in or adjacent this enclosure can be employed as necessary to ground the amplifier 144.

In some embodiments, the frame 192 includes at least one alignment aperture 204 such that the frame 192 can be aligned with the building structure (e.g., wall stud 188, drywall, plaster, paneling) based on a predetermined recess distance. The alignment aperture 204 provides for ease of installation depending on the recess distance (i.e., whether the amplifier 144 is flush with the wall, etc.). For example, the frame 192 can be positioned according to the thickness of the wall material (e.g., drywall, plaster, paneling or other material that can surround the amplifier 144) such that the electrical connector 202 on the amplifier 144 can inter-engage the electrical connector on the frame 192 (for example, the outlet plug 200) when the amplifier 144 is installed in the frame 192.

In the frame and amplifier embodiment illustrated in FIGS. 6A, 6B, and 7, the amplifier 144 is received and retained within the frame 192. However, in other embodiments, the amplifier 144 can be received within an adapter frame (not shown) or other adapter structure in order to fit within the frame 192. For example, the amplifier 144 to be mounted can have different shapes than that illustrated in FIGS. 6A and 6B, such as an amplifier having a shorter width W or height H. In such cases, the amplifier can be at least partially received within an adapter frame having inside dimensions adapted to receive and retain the amplifier and having outside dimensions adapted to be received within and retained by the frame 192. In this regard, different adapter frames having different shapes and dimensions can be employed to mount different amplifiers having different shapes and dimensions in the frame 192. The manners in which to secure the amplifier 144 directly to the frame 192 as described above can be employed to secure the adapter frame within the frame 192, if desired.

As described above, the outlet plug 200 and other electrical connectors can be integral with or mounted to the frame 192 to be properly positioned in a building structure cavity for connection to one or more electrical connectors 202 on an amplifier 144. In other embodiments, the outlet plug 200 (and/or other electrical connector(s) as described above) can be mounted to or integral with other elements performing the same function of positioning the outlet plug 200 with respect to the building structure cavity. The outlet plug 200 can be located on any member, element, or other structure (not shown) that is adapted to be connected to a stud 188 or other adjacent building structure in which the amplifier 144 is inserted. Such members, elements or other structure include, without limitation, one or more brackets, arms, bosses, panels, and the like extending to a location adjacent an installed amplifier 144 such that the electrical connector 202 on the amplifier 144 is electrically coupled with the outlet plug 200 when the amplifier 144 is installed in the cavity of the building structure. Also, such members, elements, or other structure need not necessarily support any part of the amplifier 144 when installed.

In some embodiments, the female-configured outlet plug 200 of the present invention connects to the house or building electrical system (not shown). With reference to the illustrated exemplary embodiment of FIG. 7 for example, when the amplifier 144 is installed in the frame 192, a male electrical connector 202 on the amplifier 144 engages with the female-configured outlet plug 200 on the frame 192 to receive and provide power to the amplifier 144.

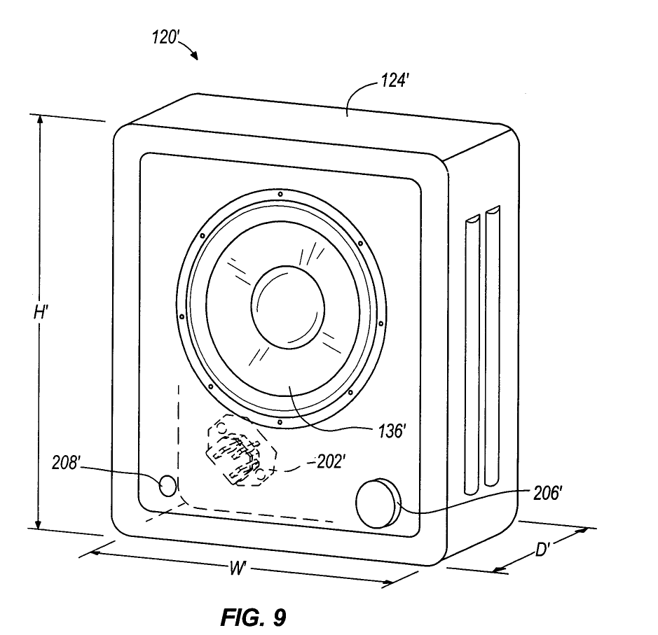

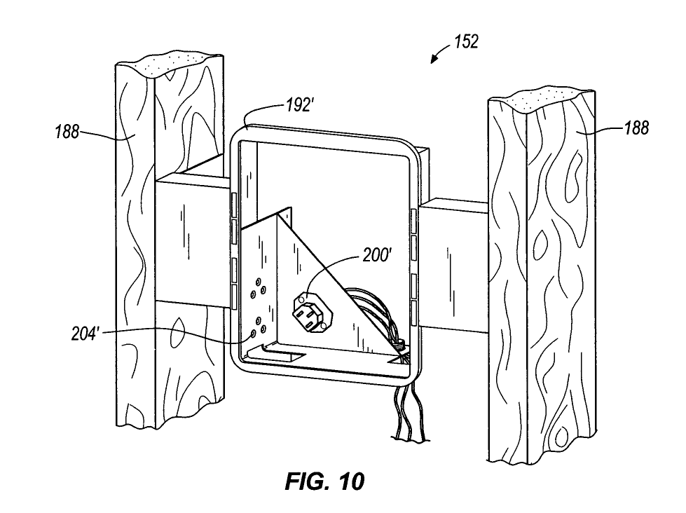

The use of a frame 192 and/or electrical (e.g., power and signal) connectors as described above can provide significant advantages to mounting an amplifier 144 in a recessed manner within a wall or other building structure. However, the structure and features of the frame 192 and of the electrical connectors 200 (and the alternatives thereof) described above can also be employed for mounting a subwoofer in a recessed manner within a wall or other building structure. By way of example only, FIGS. 9 and 10 illustrate another embodiment of the present invention in which a frame 192′ is employed to mount a subwoofer 120′ in a recessed manner within a wall. The description above regarding the features, elements, and alternatives thereto of the frame 192 and electrical connector(s) 200 apply equally to the features and elements employed with reference to the installation and mounting of subwoofers such as the subwoofer 120′ described in greater detail below. Accordingly, features and elements illustrated in FIGS. 9 and 10 and described herein are given the same primed reference numerals as corresponding features and elements illustrated in FIGS. 6A, 6B, and 7.

The subwoofer 120′ illustrated in FIG. 9 is a powered subwoofer having an amplifier (not shown) therein, a user-manipulatable volume control 206′, and an light 208′ indicating the powered status of the subwoofer 120′. If desired, the subwoofer 120′ can employ any of the features and elements described above with reference to the powered subwoofer illustrated in FIGS. 1 and 2. However, in other embodiments, the subwoofer 120′ has no amplifier therein, and/or has no user-manipulatable controls or indicator lights. Also, in some alternative embodiments the subwoofer housing 124′ can include one or more other drivers having different frequencies, such as a mid-range and/or tweeter drivers, as desired.

The subwoofer 120′ illustrated in FIG. 9 has an electrical connector 202′ on a rear surface thereof, and is positioned to electrically connect to an electrical connector 200′ on the frame 192′ in a manner similar to the electrical connections described above with reference to the amplifier 144 and frame 192 illustrated in FIGS. 6A, 6B, and 7. Therefore, the subwoofer 120′ can be inserted within the frame 192′ after the frame 192′ has been mounted to the building structure as described above. By inserting the subwoofer 120′ in the frame 192′, the electrical connection is made between the electrical connectors 200′, 202′ to power the subwoofer 120′. As with the exemplary amplifier 144 of FIGS. 6A and 6B, any number of electrical connectors can be positioned on the subwoofer 120 for electrical connection to any number of electrical connectors on the frame 192′ (or other connector mounting and positioning structure as also described above).

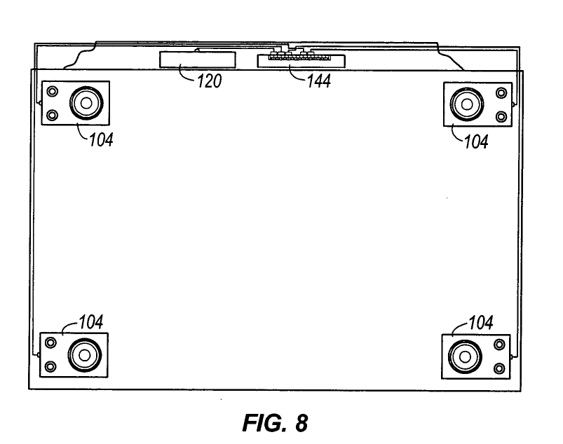

FIG. 8 illustrates a wiring schematic of the speakers 104, subwoofer 120, and amplifier 144 of the exemplary system illustrated in FIG. 3. The wires from speakers 104 and subwoofer 120 connect to the terminals 182 on the top surface of the exemplary amplifier 144 illustrated in FIGS. 6A and 6B. In some embodiments, the frame 192 includes at least one aperture through which amplifier wiring extends. The wires can be pulled behind the walls, positioned under the flooring, run through the ceiling of the room, or can connect to the amplifier 144 in any suitable manner.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A subwoofer speaker adapted for recessed installation in a building structure, the subwoofer speaker comprising:
a housing having
a height;
a width; and
a depth, the depth of the housing dimensioned to be recessed within the building structure;
a driver movable to produce waves; and
an elongated internal chamber within the housing and through which waves produced by the driver propagate, the elongated chamber having a height along the height of the housing and a cross-sectional width, the height of the chamber being no less than 2.7 times the width of the chamber.

2. The subwoofer speaker of claim 1, wherein the housing is adapted to be recessed within the building structure along substantially the entire height of the housing.

3. The subwoofer speaker of claim 1, wherein the height of the chamber is no less than 5.0 times the width of the chamber.

4. The subwoofer speaker of claim 3, wherein the housing is adapted to be recessed within the building structure along substantially the entire height of the housing.

5. The subwoofer speaker of claim 1, wherein:
the housing is adapted for installation within a cavity between two substantially parallel elongated structural members; and
the width of the housing is no greater than 16 inches and is received between the structural members.

6. The subwoofer speaker of claim 1, wherein the housing is adapted for installation in a cavity having a depth of no greater than four inches, and wherein the depth of the housing is no greater than four inches.

7. The subwoofer speaker of claim 1, further comprising at least one bracket coupled to the housing and adapted to be mounted to the building structure.

8. The subwoofer speaker of claim 7, wherein the at least one bracket is releasably coupled to the housing.

9. The subwoofer speaker of claim 1, wherein the internal chamber has a cross-sectional depth, and wherein the height of the internal chamber is not less than 5.5 times the cross-sectional depth.

10. The subwoofer speaker of claim 1, wherein the internal chamber has a cross-sectional depth, and wherein the height of the internal chamber is not less than 11.5 times the cross-sectional depth.

11. The subwoofer speaker of claim 1, wherein the internal chamber has a cross-sectional depth, and wherein the height of the internal chamber is not less than 23.0 times the cross-sectional depth.

12. The subwoofer speaker of claim 1, wherein the housing has a cross-sectional shape along the depth of the housing that is substantially rectangular.

13. The subwoofer speaker of claim 1, wherein the driver is oriented at least 45 degrees with respect to a longitudinal axis of the elongated chamber.

14. The subwoofer speaker of claim 1, wherein the driver is oriented at least 80 degrees with respect to a longitudinal axis of the elongated chamber.

15. The subwoofer speaker of claim 1, wherein the driver is oriented approximately 90 degrees with respect to a longitudinal axis of the elongated chamber.

16. An amplifier adapted for recessed installation in a building structure, the amplifier comprising:
a housing having
a height,
a width, and
a depth, the depth of the housing dimensioned to be recessed within the building structure;
a power supply circuit located within the housing; and
an audio amplifier circuit located within the housing and coupled to the power supply circuit for receiving power therefrom, the audio amplifier circuit adapted to be coupled to a source of audio signals;
wherein the height of the housing is no less than 3.0 times the depth of the housing, and the width of the housing is no less than 2.0 times the depth of the housing.

17. The amplifier of claim 16, wherein the audio amplifier circuit includes a class-D audio amplifier.

18. The amplifier of claim 16, wherein the power supply circuit includes a power transformer coupled to a rectifier and a filter circuit.

19. The amplifier of claim 18, wherein the power transformer comprises a toroidal power transformer.

20. The amplifier of claim 16, wherein the housing is adapted to be recessed within the building structure along substantially the entire height of the housing.

21. The amplifier of claim 16, wherein the height of the housing is no less than 4.0 times the depth of the housing.

22. The amplifier of claim 16, wherein the height of the housing is no less than 5.0 times the depth of the housing.

23. The amplifier of claim 16, wherein the width of the housing is no less than 3.0 times the depth of the housing.

24. The amplifier of claim 16, wherein the width of the housing is no less than 4.0 times the depth of the housing.

25. The amplifier of claim 16, wherein:
the housing is adapted for installation in a cavity between two substantially parallel elongated structural members; and
the width of the housing is no greater than 16 inches and is received between the structural members.

26. The amplifier of claim 16, wherein:
the housing is adapted for installation in a cavity having a depth of no greater than four inches; and
the depth of the housing is no greater than four inches.

27. A subwoofer speaker adapted for recessed installation in a building structure, the subwoofer speaker comprising:
an elongated housing having
a height defined along a longitudinal axis of the elongated housing,
a width, and
a depth, the depth of the elongated housing dimensioned to be recessed within the building structure;
an internal chamber defined by walls of the elongated housing, the internal chamber having
a height extending along the longitudinal axis of the elongated housing, and
a width,
the height of the chamber being no less than 2.7 times the width of the chamber; and
a driver movable to generate waves propagating from the driver in a direction oriented at least 45 degrees with respect to the longitudinal axis of the elongated chamber.

28. The subwoofer speaker of claim 27, wherein the driver comprises a speaker cone having an axis of movement defining the direction.

29. The subwoofer speaker of claim 27, wherein the waves propagate from the driver in a direction oriented at least 80 degrees with respect to the longitudinal axis of the elongated chamber.

30. The subwoofer speaker of claim 27, wherein the waves propagate from the driver in a direction oriented approximately 90 degrees with respect to the longitudinal axis of the elongated chamber.

31. The subwoofer speaker of claim 30, wherein the driver is positioned at an end of the elongated housing.

32. The subwoofer speaker of claim 27, wherein the driver is positioned at an end of the elongated housing.

33. The subwoofer speaker of claim 32, wherein the driver is positioned to face outwardly from the building structure when the speaker is installed in the building structure.

34. The subwoofer speaker of claim 27, further comprising an air port through which sound waves propagate, the air port establishing fluid communication between the internal chamber and an area outside of the elongated housing.

35. The subwoofer speaker of claim 34, wherein the air port is defined in a side of the elongated housing, and has an elongated cross-sectional shape.

36. The subwoofer speaker of claim 27, wherein the height of the internal chamber is no less than 5.0 times the width of the internal chamber.

37. A method of producing sound with a subwoofer speaker, comprising:
moving a subwoofer driver to generate sound waves;
propagating the sound waves within and along an elongated chamber recessed within a building structure, the elongated chamber having a longitudinal axis, a height along the building structure and the longitudinal axis, and a depth recessed within the building structure, the height of the elongated chamber being no less than 5.5 times the depth of the elongated chamber; and
emitting sound waves from a surface of the subwoofer driver to an area adjacent the building structure in a direction oriented at least 45 degrees with respect to the longitudinal axis of the elongated chamber.

38. The method of claim 37, wherein the sound waves are emitted from the surface of the subwoofer driver in a direction oriented at least 80 degrees with respect to the longitudinal axis of the elongated chamber.

39. The method of claim 37, wherein the sound waves are emitted from the surface of the subwoofer driver in a direction oriented at least 90 degrees with respect to the longitudinal axis of the elongated chamber.

40. The method of claim 39, wherein the height of the elongated chamber is no less than 11.5 times the depth of the elongated chamber.

41. The method of claim 37, wherein the height of the elongated chamber is no less than 11.5 times the depth of the elongated chamber.

42. The method of claim 37, wherein the height of the elongated chamber is no less than 23.0 times the depth of the elongated chamber.

43. The method of claim 37, further comprising emitting sound from a port extending between the chamber and the area adjacent to the building structure.

44. The method of claim 37, further comprising reflecting the sound waves from an end of the housing opposite the driver.

45. An amplifier mounting structure for mounting an amplifier in a recessed position within a building structure, the amplifier mounting structure comprising:
a frame shaped to receive the amplifier, the frame having at least one mounting location at which the frame is adapted to be mounted within a cavity in the building structure; and
a fastener connecting the amplifier to and within the frame.

46. The amplifier mounting structure of claim 45, wherein the frame substantially surrounds the amplifier.

47. The amplifier mounting structure of claim 45, wherein the frame is substantially rectangular and receives a rear portion of the amplifier.

48. The amplifier mounting structure of claim 45, wherein the fastener is integral with a portion of the frame.

49. The amplifier mounting structure of claim 48, wherein the fastener is releasably engagable with an element on the amplifier.

50. The amplifier mounting structure of claim 45, wherein the frame has at least one aperture through which amplifier wiring extends.

51. The amplifier mounting structure of claim 45, wherein the frame has a rear wall in facing relationship with a rear wall of the amplifier when installed in the frame.

52. The amplifier mounting structure of claim 45, wherein the frame has at least one alignment aperture by which the frame can be aligned with respect to the building structure by a pre-determined recess distance with respect to a front surface of the building structure.

53. The amplifier mounting structure of claim 45, wherein the amplifier is snap-fit into the frame.

54. The amplifier mounting structure of claim 45, wherein the frame is adapted to be mounted to adjacent studs in the building structure.

55. The amplifier mounting structure of claim 45, wherein the frame includes at least one electrical connector.

56. A method of installing an amplifier in a recessed position within a building structure, the method comprising:
mounting a frame within a cavity in the building structure;
inserting a rear portion of the amplifier into the cavity and inside the frame;
pushing the amplifier to a recessed position within the building structure; and
supporting the amplifier within the frame.

57. A bracket for electrically connecting an amplifier having an electrical connector and recessed within a cavity of a building structure, the bracket comprising:
a first portion adapted to be mounted to the building structure in a first location within the cavity;
a second portion extending to a second location a distance from the first location; and
an electrical connector mounted to the second portion at the second location, the electrical connector of the bracket positioned in the second location to connect with the electrical connector of the amplifier upon insertion of the amplifier into the cavity.

58. The bracket of claim 57, wherein the bracket is part of a frame shaped to receive the amplifier.

59. The bracket of claim 57, wherein the second portion is fixed with respect to the first portion.

60. The bracket of claim 57, wherein the bracket is adapted to at least partially support the amplifier in the cavity.

61. The bracket of claim 57, wherein the electrical connector is at least one of a power connector and an audio signal connector.

62. A method of electrically connecting an amplifier within a building structure, the method comprising:
inserting the amplifier into a cavity of the building structure;
pushing the amplifier into a recessed position within the cavity; and
establishing an electrical connection to the amplifier by pushing the amplifier into the recessed position within the cavity.

63. The method of claim 62, wherein inserting the amplifier includes inserting the amplifier into a frame recessed within the building structure.

64. The method of claim 63, wherein inserting the amplifier includes fastening the amplifier within the frame.

65. The method of claim 62, wherein the electrical connection is at least one of a power connection and an audio signal connection.

66. The method of claim 62, wherein establishing an electrical connection includes connecting an electrical connector on the amplifier to an electrical connector within the cavity.

67. The method of claim 66, wherein the electrical connector is connected to a wall within the cavity.
